(19) United States
(12) Patent Application Publication
(10) Pub. No.: US 2026/0245527 A1
(43) Pub. Date: Aug. 20, 2026

(54) DISPLAY DEVICE

(71) Applicant: Sharp Display Technology Corporation, Kameyama City (JP)

(72) Inventor: Yoshiyuki KURIOKA, Kameyama City (JP)

(21) Appl. No.: 19/531,194

(22) Filed: Feb. 5, 2026

(30) Foreign Application Priority Data
Feb. 14, 2025 (JP) 2025-022884

(51) Int. Cl. G09G 3/36

(52) U.S. Cl. CPC G09G 3/3677; G09G 2310/08; G09G 2320/041; G09G 2330/021

(57) ABSTRACT

A display device includes a gate line 11a connected to a TFT, a gate line 11b connected to the TFT, a source line 12a and a source line 12b, a gate drive circuit that outputs a gate signal, a source drive circuit that outputs a source signal, and a control circuit. The gate drive circuit selects, in accordance with a gate control signal from the control circuit, any one of a first state in which a gate signal is output to the gate line 11a and no gate signal is output to the gate line 11b and a second state in which a gate signal is output to the gate line 11a and a signal having the same frequency as the gate signal and having a different phase from the gate signal is output to the gate line 11b.

### CROSS-REFERENCE TO RELATED APPLICATIONS

This application claims the benefit of priority to Japanese Patent Application Number 2025-022884 filed on February 14, 2025. The entire contents of the above-identified application are hereby incorporated by reference.

### BACKGROUND

### TECHNICAL FIELD

The disclosure relates to a display device.

JP 2000-112437 A discloses an active matrix liquid crystal display device. The liquid crystal display device includes a plurality of thin film transistors, a gate drive circuit, a plurality of data lines, a plurality of image signal lines, and a plurality of sampling switches. A serial-parallel conversion signal obtained by converting serial data into parallel data is supplied to each of the plurality of image signal lines as an image signal. Image signals for six pixels are sequentially output in parallel to six image signal lines. Each of the plurality of data lines is connected to one of the six image signal lines via a sampling switch. The plurality of data lines are supplied with image signals via a sampling switch.

### SUMMARY

In the liquid crystal display device as described in JP 2000-112437 A, it is desired to reduce power consumption in the gate drive circuit and to reduce an amount of heat generation in the gate drive circuit.

Thus, the disclosure has been conceived to solve the problems as described above, and an object of the disclosure is to provide a display device capable of reducing power consumption in a gate drive circuit and reducing an amount of heat generation in a gate drive circuit.

In order to solve the above-mentioned problems, a display device according to one aspect of the disclosure includes a plurality of transistors arranged in a matrix shape, a first scanning line group including a first scanning line connected to a first transistor, out of the plurality of transistors, and a second scanning line connected to the first transistor, a source line group including a plurality of source lines connected to the plurality of transistors, a gate drive circuit that outputs a gate signal, a source drive circuit that outputs a source signal to the plurality of source lines, and a control circuit that supplies a gate control signal to the gate drive circuit. The gate drive circuit selects, in accordance with the gate control signal, any one of a first state in which the gate signal is output to the first scanning line and no gate signal is output to the second scanning line, and a second state in which the gate signal is output to the first scanning line and a signal having the same frequency as the gate signal output to the first scanning line and having a different phase from the gate signal is output to the second scanning line.

According to the above configuration, it is possible to reduce power consumption in the gate drive circuit and reduce the amount of heat generation in the gate drive circuit.

### BRIEF DESCRIPTION OF DRAWINGS

The disclosure will be described with reference to the accompanying drawings, wherein like numbers reference like elements.

FIG. 1 is a block diagram illustrating a schematic configuration of a display device 100 according to the present embodiment.

FIG. 2 is a diagram illustrating a configuration of a part of a gate drive circuit 1 and a part of a source drive circuit 2 according to the present embodiment.

FIG. 3 is a diagram for describing regions R1a to R3a in a display panel 10.

FIG. 4 is a diagram for describing regions R1b to R3b in the display panel 10.

FIG. 5 is a timing chart for describing an operation of the gate drive circuit 1 when a TFT 13 in the region R1a is scanned at 30 Hz.

FIG. 6 is a timing chart for describing an operation of the gate drive circuit 1 when the TFT 13 in the region R1a is scanned at 60 Hz.

FIG. 7 is a timing chart for describing an operation of the gate drive circuit 1 when the TFT 13 in the region R1a is scanned at 60 Hz.

FIG. 8 is a timing chart for describing an operation of the gate drive circuit 1 when the TFT 13 in the region R1a is scanned at 120 Hz.

FIG. 9 is a table showing an example of a gate signal output when the TFT 13 in the region R1a, the TFT 13 in the region R2a, and the TFT 13 in the region R3a are operated at different frequencies.

FIG. 10 is a timing chart for describing an operation of the source drive circuit 2 when the source signal is supplied to the TFT 13 in the region R1b at 30 Hz.

FIG. 11 is a timing chart for describing an operation of the source drive circuit 2 when the source signal is supplied to the TFT 13 in the region R1b at 60 Hz.

FIG. 12 is a timing chart for describing an operation of the source drive circuit 2 when the source signal is supplied to the TFT 13 in the region R1b at 60 Hz.

FIG. 13 is a timing chart for describing an operation of the source drive circuit 2 when the source signal is supplied to the TFT 13 in the region R1b at 120 Hz.

FIG. 14 is a table showing an example of a case where source signals having different frequencies are supplied to the TFT 13 in the region R1b, the TFT 13 in the region R2b, and the TFT 13 in the region R3b.

FIG. 15 is a diagram for describing a polarity of a source signal.

FIG. 16 is a table showing measurement results of a consumption current and a temperature according to an example of one embodiment.

FIG. 17 is a diagram illustrating a configuration of a display device 200 according to a first modified example of one embodiment.

FIG. 18 is a diagram illustrating a configuration of a display device 300 according to a second modified example of one embodiment.

FIG. 19 is a diagram illustrating a configuration of a display device 400 according to a third modified example of one embodiment.

FIG. 20 is a diagram illustrating a configuration of a display device 500 according to a fourth modified example of one embodiment.

### DESCRIPTION OF EMBODIMENTS

Embodiments of the disclosure will be described below with reference to the drawings. Note that the disclosure is not limited to the following embodiments, and appropriate design changes can be made within a scope that satisfies the configuration of the disclosure. In the description below, the same reference signs are used in common among the different drawings for portions having the same or similar functions, and repeated descriptions thereof will be omitted. Further, the configurations described in the embodiments and the modified examples may be combined or modified as appropriate within a range that does not depart from the gist of the disclosure. For ease of explanation, in the drawings referenced below, the configuration is simplified or schematically illustrated, or some components are omitted.

### Overall Configuration of Display Device

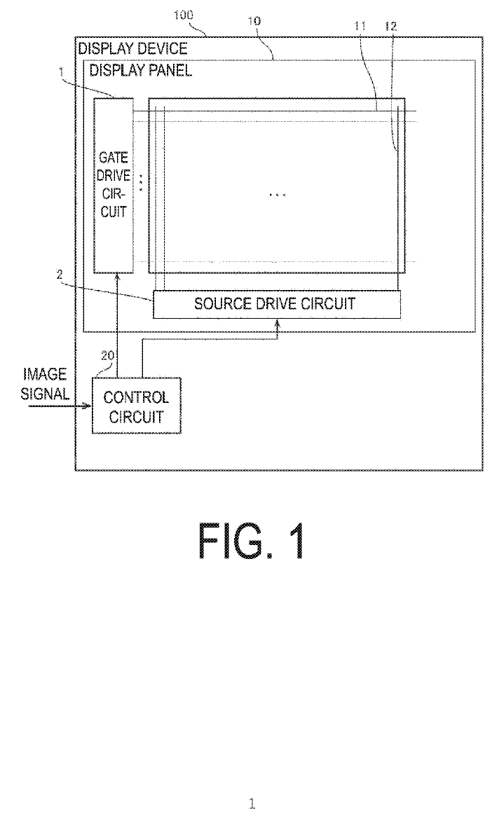

FIG. 1 is a block diagram illustrating a schematic configuration of a display device 100 according to the present embodiment. The display device 100 is a device that displays an image (video), based on an image signal supplied from a host controller (not illustrated). The display device 100 is, for example, a personal computer, a tablet terminal, a smartphone, a smartwatch, or a television device. The display device 100 includes a display panel 10 and a control circuit 20.

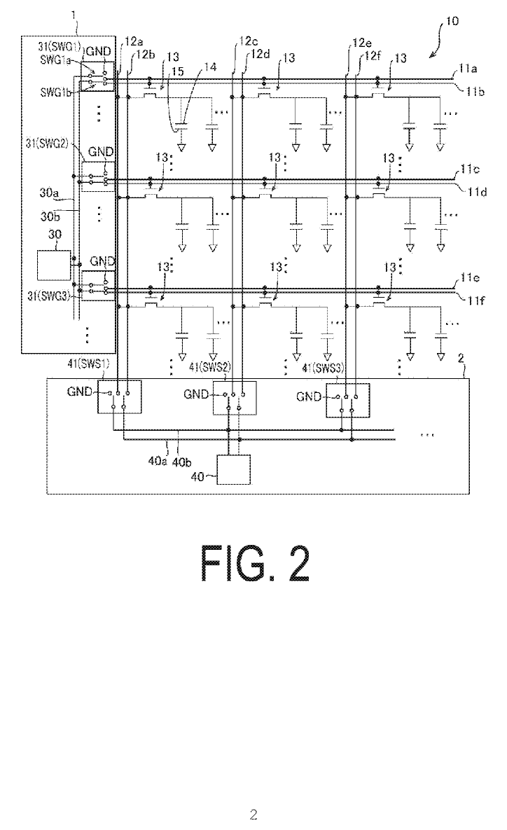

The display panel 10 includes a gate drive circuit 1 and a source drive circuit 2, as illustrated in FIG. 1. FIG. 2 is a diagram illustrating a configuration of a part of the gate drive circuit 1 and a part of the source drive circuit 2 according to the present embodiment. As illustrated in FIG. 2, the display panel 10 includes gate lines 11a to 11f connected to the gate drive circuit 1, source lines 12a to 12f connected to the source drive circuit 2, a thin film transistor (TFT) 13, a pixel electrode 14, and a common electrode 15.

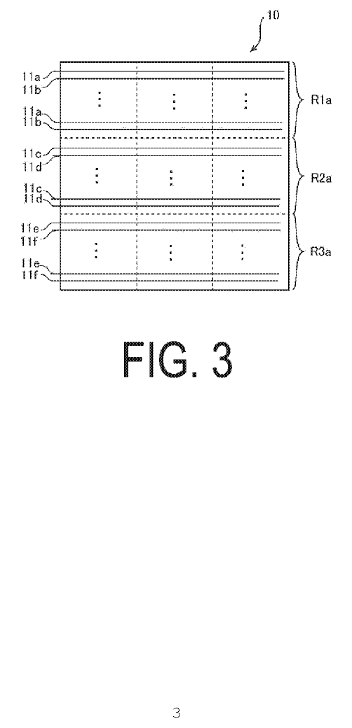

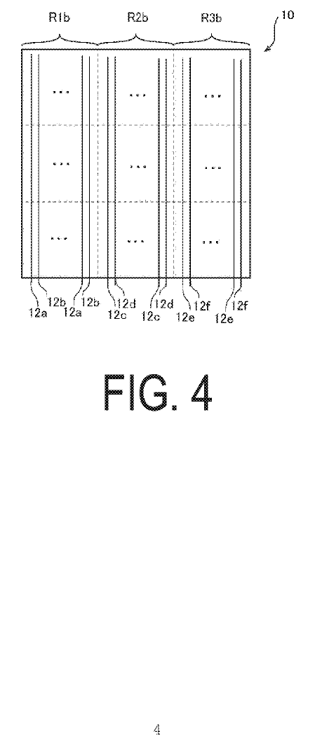

FIG. 3 is a diagram for describing regions R1a to R3a in the display panel 10. FIG. 4 is a diagram for describing regions R1b to R3b in the display panel 10. As illustrated in FIG. 3, in the display panel 10, the region R1a, the region R2a, and the region R3a are provided in this order in a direction in which the gate lines 11a to 11f are arranged. In the region R1a, a plurality of the gate lines 11a and a plurality of the gate lines 11b (first scanning line group) are arranged. In the region R2a, a plurality of the gate lines 11c and a plurality of the gate lines 11d (second scanning line group) are arranged. In the region R3a, a plurality of the gate lines 11e and a plurality of the gate lines 11f (third scanning line group) are arranged.

As illustrated in FIG. 4, in the display panel 10, the region R1b the region R2b and the region R3bare provided in this order in a direction in which the source lines 12a to 12f are arranged. In the region R1b, a plurality of the source lines 12a and a plurality of the source lines 12b (first source line group) are arranged. In the region R2b, a plurality of the source lines 12c and a plurality of the source lines 12d (second source line group) are arranged. In the region R3b, a plurality of the source lines 12e and a plurality of the source lines 12f (third source line group) are arranged.

As illustrated in FIG. 2, two gate lines are connected to each TFT 13 in one row. For example, the gate line 11a and the gate line 11b are connected to the gate electrode of each TFT 13 in the region R1a. The gate line 11c and the gate line 11d are connected to the gate electrode of each TFT 13 in the region R2a. The gate line 11e and the gate line 11f are connected to the gate electrode of each TFT 13 in the region R3a. As illustrated in FIG. 2, two source lines are connected to each TFT 13 in one row. For example, the source line 12a and the source line 12b are connected to the source electrode of each TFT 13 in the region R1b. The source line 12c and the source line 12d are connected to the source electrode of each TFT 13 in the region R2b. The source line 12e and the source line 12f are connected to the source electrode of each TFT 13 in the region R3b.

The pixel electrode 14 is connected to a drain electrode of the TFT 13. The TFT 13 and the pixel electrode 14 are arranged in a region (pixel) defined by a plurality of gate lines and a plurality of source lines intersecting. The common electrode 15 is a counter electrode disposed to face the pixel electrode 14. The common electrode 15 is provided in common for a plurality of the pixel electrodes 14.

In the first embodiment, the gate drive circuit 1 includes a signal output unit 30, a plurality of switches 31, and conductor lines 30a and 30b connecting the signal output unit 30 and the plurality of switches 31. The signal output unit 30 supplies a signal G1 to each switch 31 via the conductor line 30a. The signal output unit 30 supplies a signal G2 to each switch 31 via the conductor line 30b. The source drive circuit 2 includes a signal output unit 40, a plurality of switches 41, and conductor lines 40a and 40b connecting the signal output unit 40 and the plurality of switches 41. The signal output unit 40 supplies a signal S1 to each switch 41 via the conductor line 40a. The signal output unit 40 supplies a signal S2 to each switch 41 via the conductor line 40b.

The control circuit 20 supplies a gate control signal to the gate drive circuit 1. The control circuit 20 also supplies a source control signal to the source drive circuit 2. In the present embodiment, the gate control signal includes a signal for operating the plurality of switches 31. The source control signal includes a signal for operating the plurality of switches 41. As illustrated in FIG. 2, the plurality of switches 31 include a switch SWG1 connected to the gate lines 11a and 11b, a switch SWG2 connected to the gate lines 11c and 11d, and a switch SWG3 connected to the gate lines 11e and 11f. The plurality of switches 41 include a switch SWS1 connected to the source lines 12a and 12b, a switch SWS2 connected to the source lines 12c and 12d, and a switch SWS3 connected to the source lines 12e and 12f.

### Operation of Gate Drive Circuit 1

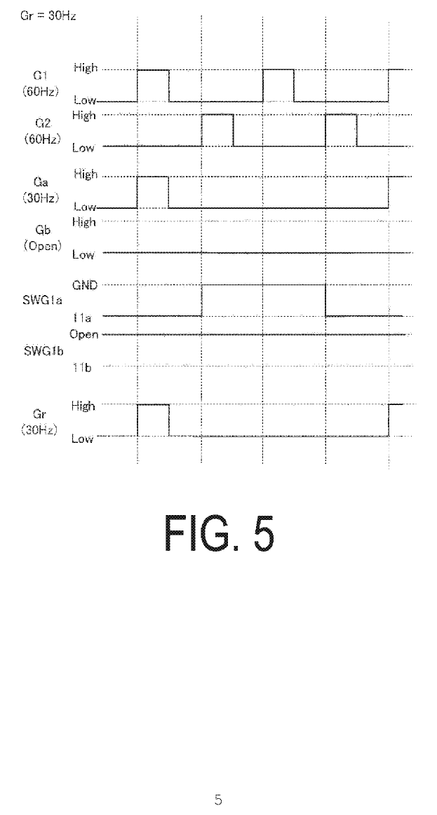

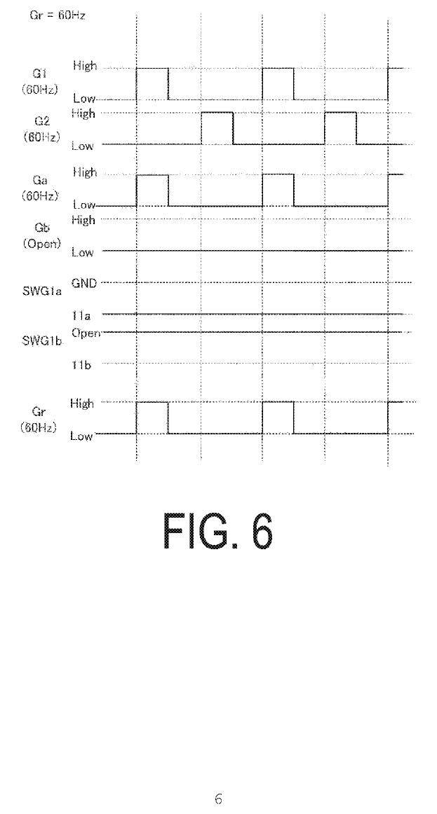

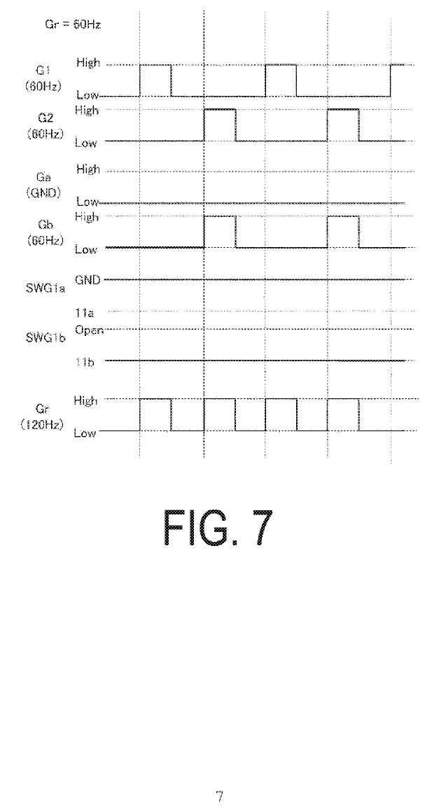

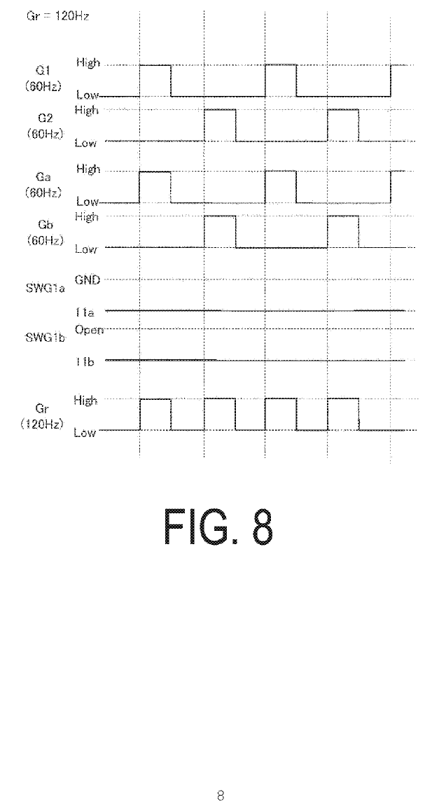

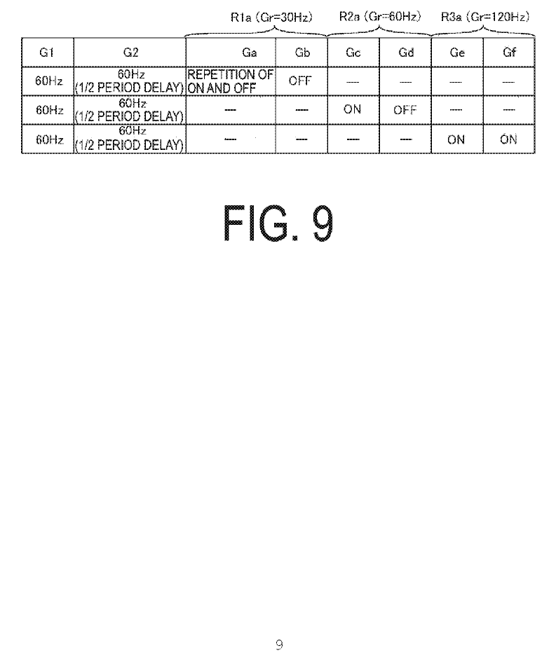

Next, an operation of the gate drive circuit 1 according to the present embodiment will be described with reference to FIGS. 5 to 9. FIG. 5 is a timing chart for describing an operation of the gate drive circuit 1 when the TFT 13 in the region R1a is scanned at 30 Hz. FIGS. 6 and 7 are timing charts for describing an operation of the gate drive circuit 1 when the TFT 13 in the region R1a is scanned at 60 Hz. FIG. 8 is a timing chart for describing an operation of the gate drive circuit 1 when the TFT 13 in the region R1a is scanned at 120 Hz. FIG. 9 is a table showing an example of a gate signal output when the TFT 13 in the region R1a, the TFT 13 in the region R2a, and the TFT 13 in the region R3a are operated at different frequencies. Note that, although an example of a gate signal Gr supplied to the TFT 13 in the region R1a will be described in FIGS. 5 to 8, the TFT 13 in the region R2a and the TFT 13 in the region R3a also operate in the same manner as the TFT 13 in the region R1a, and thus, the description of the operations of the TFT 13 in the region R2a and the TFT 13 in the region R3a will be omitted.

In the present embodiment, the plurality of switches SWG1 select, in accordance with the gate control signal, any one of a state in which a part (half) of the gate signal G1 is output to the gate line 11a and the gate signals G1 and G2 are not output to the gate line 11b (see FIG. 5), a state in which the gate signal G1 is output to the gate line 11a and the gate signals G1 and G2 are not output to the gate line 11b (see FIG. 6), and a state in which the gate signal G1 is output to the gate line 11a and a gate signal G2 having the same frequency as the gate signal G1 and having a different phase from the gate signal G1 is output to the gate line 11b (see FIG. 8). As illustrated in FIG. 2, the switch SWG1 includes a switch SWG1a that switches between a state in which the gate line 11a and the ground GND are connected and a state in which the gate line 11a and the conductor line 30a are connected in accordance with the gate control signal. The switch SWG1 includes a switch SWG1b that switches between a state in which the gate line 11b and the conductor line 30a are connected to each other and a state in which the gate line 11b is open (Open state) in accordance with the gate control signal.

As illustrated in FIGS. 5 to 8, Gr denotes a gate signal input to the gate electrode of the TFT 13. The signal output unit 30 outputs the gate signal G1 and the gate signal G2 to the switch SWG1. The frequency of the gate signal G1 is 60 Hz. The frequency of the gate signal G2 is 60 Hz, and the gate signal G2 is delayed in phase by one half period (π) with respect to the gate signal G1. Note that in FIGS. 5 to 8, scanning is performed once in a period in which the gate signal G1 is High once.

As shown in FIG. 5, in order to set the frequency of the gate signal Gr to 30 Hz, the control circuit 20 connects the switch SWG1a of the gate drive circuit 1 to the ground GND at the frequency of 30 Hz. Thus, the frequency of the gate signal Ga output to the gate line 11a is 30 Hz. The control circuit 20 also sets the switch SWG1b of the gate drive circuit 1 to the Open state. As a result, no gate signal is output to the gate line 11b. As a result, the frequency of the gate signal Gr input to the TFT 13 is 30 Hz.

As shown in FIG. 6, in order to set the frequency of the gate signal Gr to 60 Hz, the control circuit 20 sets the switch SWG1a of the gate drive circuit 1 to a state in which the conductor line 30a and the gate line 11a are connected to each other. Thus, the frequency of the gate signal Ga output to the gate line 11a is 60 Hz. The control circuit 20 also sets the switch SWG1b of the gate drive circuit 1 to the Open state. As a result, no gate signal is output to the gate line 11b. As a result, the frequency of the gate signal Gr input to the TFT 13 is 60 Hz.

As shown in FIG. 7, in another method for setting the frequency of the gate signal Gr to 60 Hz, the control circuit 20 sets the switch SWG1a of the gate drive circuit 1 to a state in which the conductor line 30a is connected to the ground GND. Thus, no gate signal is output to the gate line 11a. The control circuit 20 also sets the switch SWG1b of the gate drive circuit 1 to a state in which the conductor line 30b and the gate line 11b are connected. This brings about a state in which the gate signal Gb having 60 Hz is output to the gate line 11b. As a result, the frequency of the gate signal Gr input to the TFT 13 is 60 Hz.

As shown in FIG. 8, in order to set the frequency of the gate signal Gr to 120 Hz, the control circuit 20 sets the switch SWG1a of the gate drive circuit 1 to a state in which the conductor line 30a and the gate line 11a are connected to each other. Thus, the frequency of the gate signal Ga output to the gate line 11a is 60 Hz. The control circuit 20 also sets the switch SWG1b of the gate drive circuit 1 to a state in which the conductor line 30b and the gate line 11b are connected. This brings about a state in which the gate signal Gb having 60 Hz is output to the gate line 11b. As a result, the frequency of the gate signal Gr input to the TFT 13 is 120 Hz.

According to the above configuration, two gate lines (the gate lines 11a and 11b) are disposed for each TFT 13 in one row. Thus, in a state where the gate signal G1 is output to the gate line 11a as the gate signal Ga and the gate signal G2 is output to the gate line 11b as the gate signal Gb, the gate signal is supplied to the TFT 13 alternately from both the gate line 11a and the gate line 11b. Therefore, the frequency of the gate signal input to the TFT 13 is twice the frequency of the gate signals G1 and G2 generated in the gate drive circuit 1. As a result, the frequencies of the gate signals G1 and G2 generated in the gate drive circuit 1 can be reduced to one half of the frequency of the gate signal Gr, and thus, the power consumption in the gate drive circuit 1 can be reduced and the amount of heat generation in the gate drive circuit 1 can be reduced.

Here, as shown in FIG. 9, the control circuit 20 transmits the gate control signal to the gate drive circuit 1 so that the frequency of the gate signal Gr input to the TFT 13 in the region R1a is 30 Hz, the frequency of the gate signal Gr input to the TFT 13 in the region R2a is 60 Hz, and the frequency of the gate signal Gr input to the TFT 13 in the region R3a is 120 Hz. In such a case, the source signal Sr with 120 Hz is input from the source drive circuit 2 to the TFT 13. For example, the gate drive circuit 1 outputs the gate signal Gr shown in FIG. 5 to the TFT 13 in the region R1a, outputs the gate signal Gr shown in FIG. 6 to the TFT 13 in the region R2a, and outputs the gate signal Gr shown in FIG. 8 to the TFT 13 in the region R3a. According to the above configuration, it is possible to change the frequency for each region on the screen.

### Operation of Source Drive Circuit 2

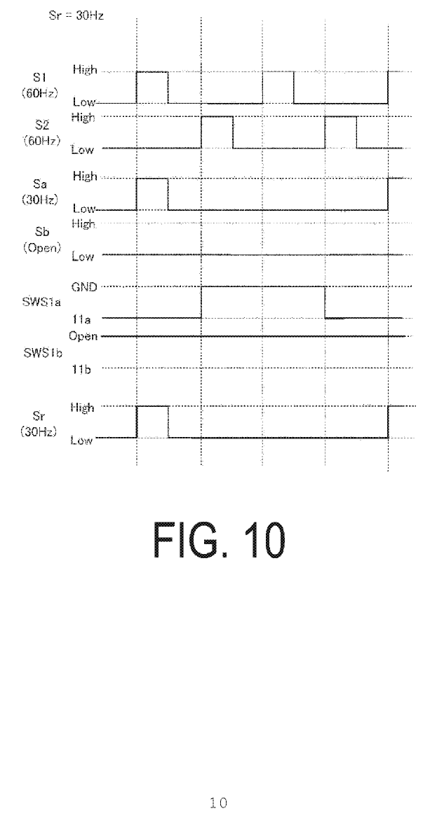

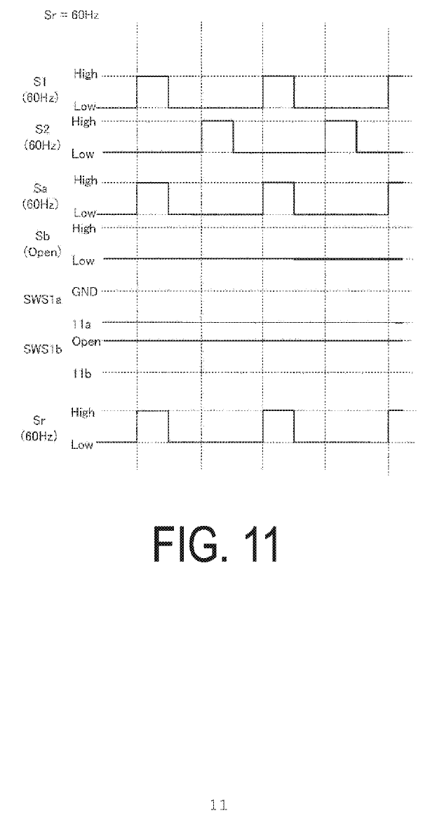

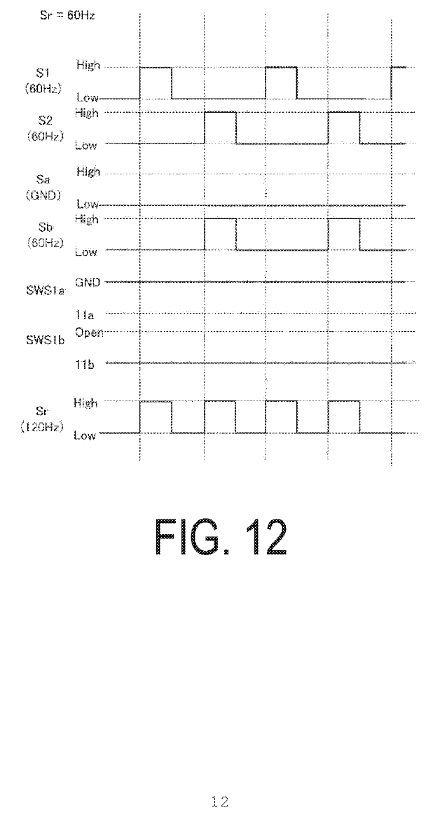

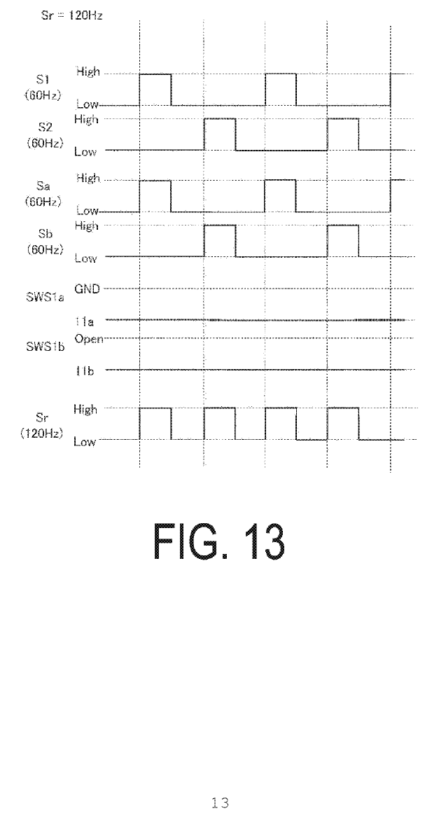

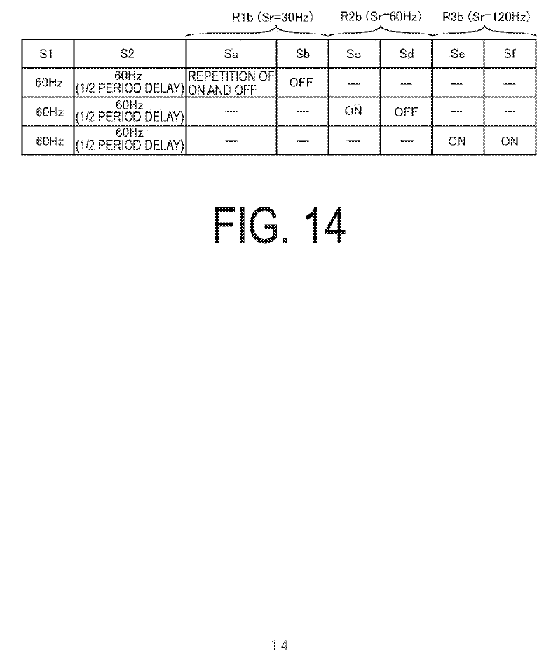

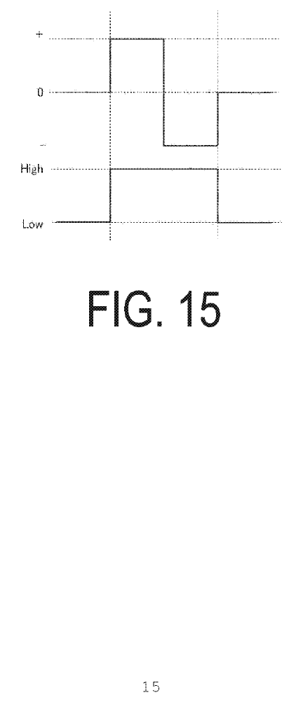

Next, an operation of the source drive circuit 2 according to the present embodiment will be described with reference to FIGS. 10 to 15. FIG. 10 is a timing chart for describing an operation of the source drive circuit 2 when the source signal with 30 Hz is supplied to the TFT 13 in the region R1b. FIGS. 11 and 12 are timing charts for describing an operation of the source drive circuit 2 when the source signal with 60 Hz is supplied to the TFT 13 in the region R1b. FIG. 13 is a timing chart for describing an operation of the source drive circuit 2 when the source signal with 120 Hz is supplied to the TFT 13 in the region R1b. FIG. 14 is a table showing an example of a case where source signals having different frequencies are supplied to the TFT 13 in the region R1b, the TFT 13 in the region R2b, and the TFT 13 in the region R3b. FIG. 15 is a diagram for describing a polarity of a source signal. Note that, although an example of the source signal Sr supplied to the TFT 13 in the region R1b will be described in FIGS. 10 to 13, the TFT 13 in the region R2b and the TFT 13 in the region R3b also operate in the same manner as the TFT 13 in the region R1b, and thus, the description of the operations of the TFT 13 in the region R2b and the TFT 13 in the region R3b will be omitted. As illustrated in FIG. 15, a period in which the source signal is High is a period including a period in which the source signal is a positive polarity and a period in which the source signal is a negative polarity, and a period in which the source signal is Low is a period in which the source signal is at the same potential as the ground GND (neither a positive polarity nor a negative polarity).

In the present embodiment, the plurality of switches SWS1 select, in accordance with the source control signal, any one of a state in which a part (half) of the source signal S1 is output to the source line 12a and the source signals S1 and S2 are not output to the source line 12b (see FIG. 10), a state in which the source signal S1 is output to the source line 12a and the source signals S1 and S2 are not output to the source line 12b (see FIG. 11), and a state in which the source signal S1 is output to the source line 12a and the source signal S2 having the same frequency as the source signal S1 and having a different phase from the source signal S1 is output to the source line 12b (see FIG. 13). As illustrated in FIG. 2, the switch SWS1 includes a switch SWS1a that switches between a state in which the source line 12a and the ground GND are connected and a state in which the source line 12a and the conductor line 40a are connected in accordance with the source control signal. The switch SWS1 includes a switch SWS1b that switches between a state in which the source line 12b and the conductor line 40a are connected to each other and a state in which the source line 12b is open (Open state) in accordance with the source control signal.

As shown in FIGS. 10 to 13, Sr denotes the source signal input to the source electrodes of the TFT 13. The signal output unit 40 outputs the source signal S1 and the source signal S2 to the switch SWS1. The frequency of the source signal S1 is 60 Hz. The frequency of the source signal S2 is 60 Hz, and the source signal S2 is delayed in phase by one half period (π) with respect to the source signal S1.

As shown in FIG. 10, in order to set the frequency of the source signal Sr to 30 Hz, the control circuit 20 connects the switch SWS1a of the source drive circuit 2 to the ground GND at the frequency of 30 Hz. Thus, the frequency of the source signal Sa output to the source line 12a is 30 Hz. The control circuit 20 also sets the switch SWS1b of the source drive circuit 2 to the Open state. Thus, no source signal is output to the source line 12b. As a result, the frequency of the source signal Sr input to the TFT 13 is 30 Hz.

As shown in FIG. 11, in order to set the frequency of the source signal Sr to 60 Hz, the control circuit 20 sets the switch SWS1a of the source drive circuit 2 to a state in which the conductor line 40a and the source line 12a are connected to each other. Thus, the frequency of the source signal Sa output to the source line 12a is 60 Hz. The control circuit 20 also sets the switch SWS1b of the source drive circuit 2 to the Open state. Thus, no source signal is output to the source line 12b. As a result, the frequency of the source signal Sr input to the TFT 13 is 60 Hz.

As shown in FIG. 12, in another method for setting the frequency of the source signal Sr to 60 Hz, the control circuit 20 sets the switch SWS1a of the source drive circuit 2 to a state in which the conductor line 40a is connected to the ground GND. Thus, no source signal is output to the source line 12a. The control circuit 20 also sets the switch SWS1b of the source drive circuit 2 to a state in which the conductor line 40b and the source line 12b are connected. This brings about a state in which the source signal Sb with 60 Hz is output to the source line 12b. As a result, the frequency of the source signal Sr input to the TFT 13 is 60 Hz.

As shown in FIG. 13, in order to set the frequency of the source signal Sr to 120 Hz, the control circuit 20 sets the switch SWS1a of the source drive circuit 2 to a state in which the conductor line 40a and the source line 12a are connected to each other. Thus, the frequency of the source signal Sa output to the source line 12a is 60 Hz. The control circuit 20 also sets the switch SWS1b of the source drive circuit 2 to a state in which the conductor line 40b and the source line 12b are connected. This brings about a state in which the source signal Sb with 60 Hz is output to the source line 12b. As a result, the frequency of the source signal Sr input to the TFT 13 is 120 Hz.

According to the above configuration, two source lines (the source lines 12a and 12b) are disposed to each TFT 13 in one row. Thus, in a state where the source signal S1 is output to the source line 12a as the source signal Sa and the source signal S2 is output to the source line 12b as the source signal Sb, the source signal is supplied to the TFT 13 alternately from both the source line 12a and the source line 12b. Therefore, the frequency of the source signal input to the TFT 13 is twice the frequency of the source signals S1 and S2 generated in the source drive circuit 2. As a result, it is possible to reduce the frequencies of the source signals S1 and S2 generated in the source drive circuit 2 to one half of the frequency of the source signal Sr, and thus, it is possible to reduce the power consumption in the source drive circuit 2 and the amount of heat generation in the source drive circuit 2.

Here, as shown in FIG. 14, the control circuit 20 transmits the source control signal to the source drive circuit 2 so that the frequency of the source signal Sr input to the TFT 13 in the region R1b is 30 Hz, the frequency of the source signal Sr input to the TFT 13 in the region R2b is 60 Hz, and the frequency of the source signal Sr input to the TFT 13 in the region R3b is 120 Hz. In such a case, the source signal Sr with 120 Hz is input from the source drive circuit 2 to the TFT 13. For example, the source drive circuit 2 outputs the source signal Sr shown in FIG. 10 to the TFT 13 in the region R1b, outputs the source signal Sr shown in FIG. 11 to the TFT 13 in the region R2b, and outputs the source signal Sr shown in FIG. 13 to the TFT 13 in the region R3b. According to the above configuration, it is possible to change the frequency for each region on the screen.

### Measurement Result of Current Consumption and Measurement Result of Change in Temperature of Display Panel 10

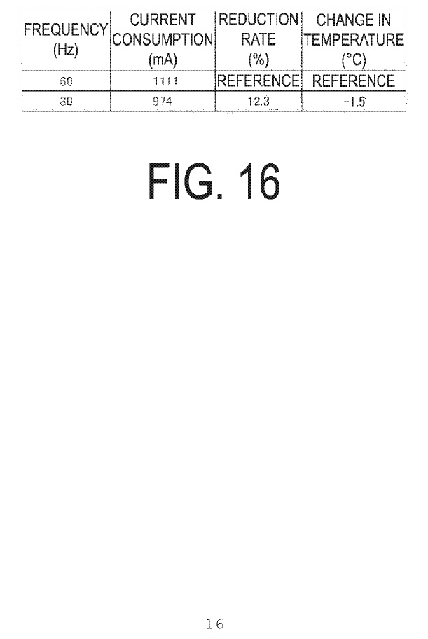

Next, a measurement result of current consumption and a measurement result of change in temperature of the display panel 10 according to an example of the present embodiment will be described with reference to FIG. 16. FIG. 16 shows measurement results of the current consumption and the temperature of the display panel 10 when the gate signal Gr input to the TFT 13 in the half region of the display panel 10 is changed from 60 Hz to 30 Hz. As shown in FIG. 16, when all the TFTs 13 in the display panel 10 were operated at 60 Hz, the current consumption was 1111 mA. When half the TFTs 13 in the display panel 10 were operated at 60 Hz and the other half of the TFTs 13 were operated at 30 Hz, the current consumption was 974 mA. Thus, the current consumption was reduced by 12.3%, and the temperature of the display panel 10 was lowered by 1.5°C. As a result, it was found that, when half the TFTs 13 in the display panel 10 were operated at 60 Hz and the other half of the TFTs 13 are operated at 30 Hz, the current consumption was reduced and the temperature was lowered (the temperature rise was small) as compared with the case where all the TFTs 13 in the display panel 10 were operated at 60 Hz.

### Modified Examples

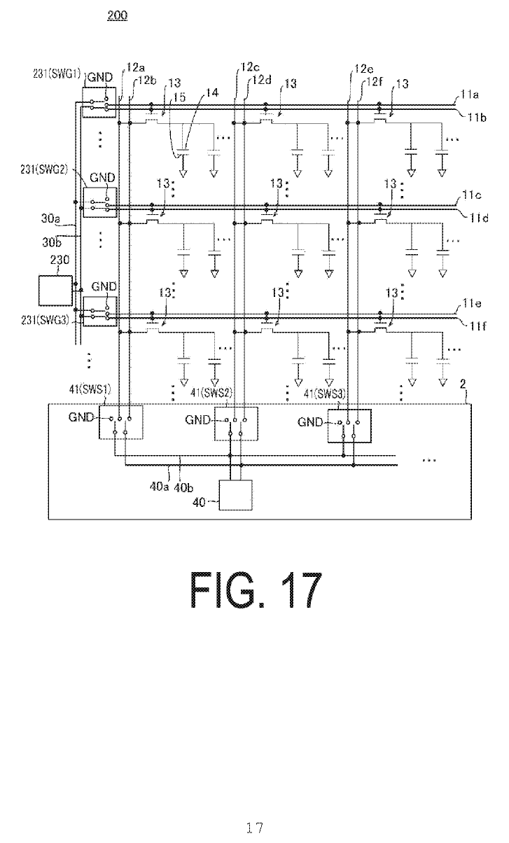

Although embodiments of the disclosure have been described above, the embodiments described above are merely examples for implementing the disclosure. Thus, the disclosure is not limited to the embodiments described above and can be implemented by appropriately modifying the embodiments described above within a range that does not depart from the gist of the disclosure. Now, modified examples of the above-described embodiments will be described.
(1) In the above embodiment, an example is described in which the signal output unit 30 and the plurality of switches 31 are integrally configured (as the gate drive circuit 1), but the disclosure is not limited thereto. As in a display device 200 according to a first modified example illustrated in FIG. 17, a signal output unit 230 (gate drive circuit) and a plurality of switches 231 may be configured separately (as separate units).

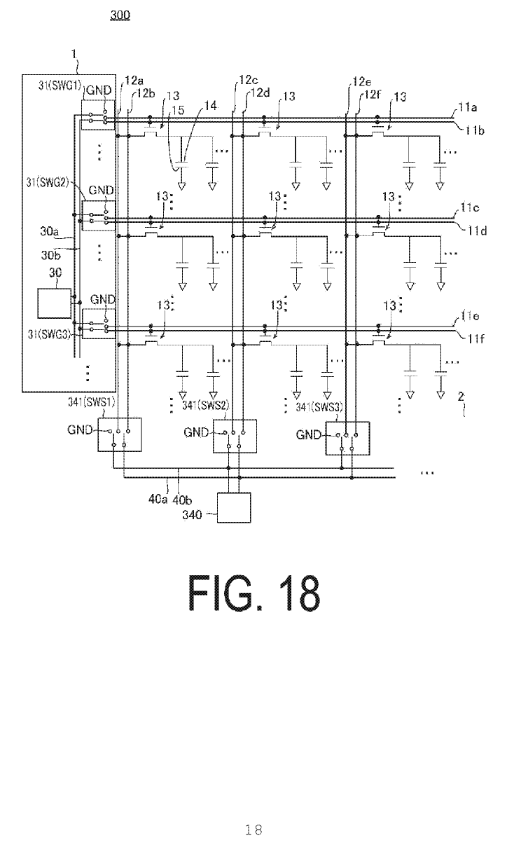

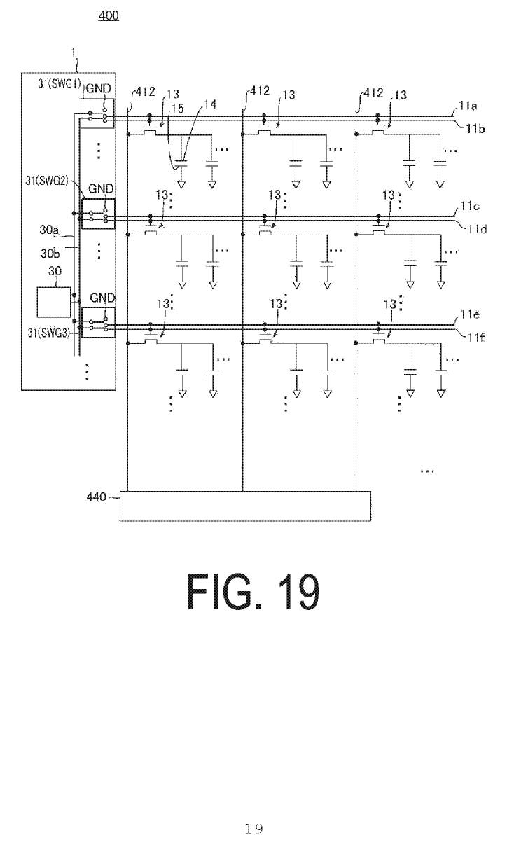

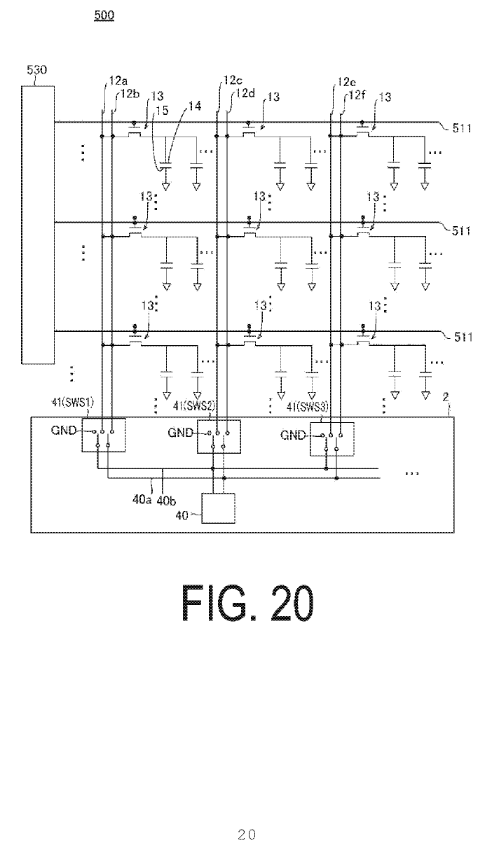

(2) In the above embodiment, an example is described in which the signal output unit 40 and the plurality of switches 41 are integrally configured (as the source drive circuit 2), but the disclosure is not limited thereto. As in a display device 300 according to a second modified example illustrated in FIG. 18, a signal output unit 340 (source drive circuit) and a plurality of switches 341 may be configured separately (as separate units).
(3) In the above embodiment, an example is described in which two gate lines and two source lines are connected to one TFT 13, but the disclosure is not limited thereto. As in a display device 400 according to a third modified example illustrated in FIG. 19, a source drive circuit 440 (signal output unit) may be configured such that one source line 412 is connected to one TFT 13 without providing a switch. As in a display device 500 according to a fourth modified example illustrated in FIG. 20, a gate drive circuit 530 (signal output unit) may be configured such that one gate line 511 is connected to one TFT 13 without providing a switch. Three or more gate lines may be connected to one TFT 13, or three or more source lines may be connected to one TFT 13.
(4) In the above embodiment, an example is described in which the polarity of the source signal output from the source drive circuit is reversed between the positive polarity and the negative polarity, but the disclosure is not limited thereto. For example, the polarity of the source signal does not have to be inverted.
(5) In the above embodiment, 30 Hz, 60 Hz, and 120 Hz are given in examples of the frequencies of the gate signal and the source signal, but the disclosure is not limited thereto. For example, a configuration may be employed in which the gate signals having frequencies other than frequencies of 30 Hz, 60 Hz, and 120 Hz are output from the gate drive circuit, and a configuration may be employed in which the source signals having frequencies other than frequencies of 30 Hz, 60 Hz, and 120 Hz are output from the source drive circuit.
(6) In the above embodiment, an example is described in which the gate signal G1 and the gate signal G2 delayed in phase by one half period (π) with respect to the gate signal G1 are output from the signal output unit, but the disclosure is not limited thereto. That is, the signal output unit may output the gate signal G1 and a gate signal delayed in phase by a length other than one half of the period with respect to the gate signal G1.

The above-described configuration can also be described as follows.

A display device according to a first configuration includes a plurality of transistors arranged in a matrix shape, a first scanning line group including a first scanning line connected to a first transistor, out of the plurality of transistors, and a second scanning line connected to the first transistor, a source line group including a plurality of source lines connected to the plurality of transistors, a gate drive circuit that outputs a gate signal, a source drive circuit that outputs a source signal to the plurality of source lines, and a control circuit that supplies a gate control signal to the gate drive circuit, in which the gate drive circuit selects, in accordance with the gate control signal, any one of a first state in which the gate signal is output to the first scanning line and no gate signal is output to the second scanning line, and a second state in which the gate signal is output to the first scanning line and a signal having the same frequency as the gate signal output to the first scanning line and having a different phase from the gate signal is output to the second scanning line (first configuration).

According to the first configuration, two scanning lines (the first scanning line and the second scanning line) are connected to the first transistor. Thus, in the second state in which the gate signal is output to the first scanning line and the signal having the same frequency as the gate signal output to the first scanning line and having a different phase from the gate signal is output to the second scanning line, the gate signals having the same frequency are supplied to the first transistor from both the first scanning line and the second scanning line at different timings. Therefore, the frequency of the gate signal supplied to the first transistor is twice the frequency of the gate signal generated in the gate drive circuit. As a result, the frequency of the gate signal generated in the gate drive circuit can be reduced to one half of that in the case where the gate signal is supplied to the first transistor via one scanning line. This makes it possible to reduce power consumption in the gate drive circuit and reduce the amount of heat generation in the gate drive circuit.

In the first configuration, the gate drive circuit may be configured to select, in accordance with the gate control signal, any one of the first state, the second state, and a third state in which a signal having a frequency equal to or less than half the frequency of the gate signal output to the first scanning line in the first state is output to the first scanning line and no gate signal is output to the second scanning line (second configuration).

According to the second configuration, in the third state, the frequency at which the first transistor is driven in the first state can be set to be equal to or lower than half the frequency at which the first transistor is driven in the first state.

In the first or second configuration, the display device may further include a second scanning line group including a third scanning line connected to the second transistor, out of the plurality of transistors, and a fourth scanning line connected to the second transistor. The gate drive circuit may be configured to select, in accordance with the gate control signal, any one of the first state and the second state, and select, in accordance with the gate control signal, any one of a fourth state in which the gate signal is output to the third scanning line and no gate signal is output to the fourth scanning line, and a fifth state in which the gate signal is output to the third scanning line and a signal having the same frequency as the gate signal output to the third scanning line and having a different phase from the gate signal is output to the fourth scanning line (third configuration).

According to the third configuration, the transistors in the region on the screen where the first scanning line group is arranged and the transistors in the region on the screen where the second scanning line group is arranged can be driven at different frequencies. As a result, it is possible to change the frequency for each region on the screen.

In the third configuration, the gate drive circuit may be configured to select, in accordance with the gate control signal, any one of the first state and the second state, and select, in accordance with the gate control signal, any one of the fourth state, the fifth state, and a sixth state in which a signal having a frequency equal to or less than half the frequency of the gate signal output to the third scanning line in the fourth state is output to the third scanning line (fourth configuration).

According to the fourth configuration, in the sixth state, the frequency at which the second transistor is driven can be set to be equal to or lower than half the frequency at which the second transistor is driven in the fourth state.

In any one of the first to fourth configurations, the source line group may include a first source line group including a first source line connected to the third transistor, out of the plurality of transistors, and a second source line connected to the third transistor. The control circuit may be configured to output a source control signal to the source drive circuit. The source drive circuit may be configured to select, in accordance with the source control signal, any one of a seventh state in which the source signal is output to the first source line and no source signal is output to the second source line, and an eighth state in which the source signal is output to the first source line and a signal having the same frequency as the source signal output to the first source line and having a different phase from the source signal is output to the second source line (fifth configuration).

According to the fifth configuration, the source signal having the same frequency is supplied to the third transistor from both the first source line and the second source line at different timings. Therefore, a signal with twice the frequency of the source signal generated in the source drive circuit can be supplied to the third transistor. Therefore, the frequency of the source signal supplied to the third transistor is twice the frequency of the source signal generated in the source drive circuit. As a result, it is possible to reduce the frequency of the source signal generated in the source drive circuit to one half of that in the case where the source signal is supplied to the third transistor via one source line. This makes it possible to reduce power consumption in the source drive circuit and reduce the amount of heat generation in the source drive circuit.

In the fifth configuration, the source drive circuit may be configured to select, in accordance with the source control signal, any one of the seventh state, the eight state, and a ninth state in which a signal having a frequency equal to or less than half the frequency of the source signal output to the first source line in the seventh state is output to the first source line and no source signal is output to the second source line (sixth configuration).

According to the sixth configuration, in the ninth state, the frequency at which the third transistor is driven can be set to be equal to or lower than half the frequency at which the third transistor is driven in the seventh state.

In the fifth or sixth configuration, the display device may further include a second source line group including a third source line connected to the fourth transistor, out of the plurality of transistors, and a fourth source line connected to the fourth transistor. The source drive circuit may be configured to select, in accordance with the source control signal, any one of the seventh state and the eighth sate, and select, in accordance with the source control signal, any one of a tenth state in which the source signal is output to the third source line and no source signal is output to the fourth source line, and an eleventh state in which the source signal is output to the third source line and a signal having the same frequency as the source signal output to the third source line and having a different phase from the source signal is output to the fourth source line (seventh configuration).

According to the seventh configuration, source signals having different frequencies can be supplied to the transistors in the region on the screen where the first source line group is arranged and the transistors in the region on the screen where the second source line group is arranged. As a result, the frequency for display can be changed for each region on the screen.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A display device comprising:
a plurality of transistors arranged in a matrix shape;
a first scanning line group including a first scanning line connected to a first transistor, out of the plurality of transistors, and a second scanning line connected to the first transistor;
a source line group including a plurality of source lines connected to the plurality of transistors;
a gate drive circuit configured to output a gate signal;
a source drive circuit configured to output a source signal to the plurality of source lines; and
a control circuit configured to supply a gate control signal to the gate drive circuit,
wherein the gate drive circuit selects, in accordance with the gate control signal,
any one of a first state in which the gate signal is output to the first scanning line and no gate signal is output to the second scanning line, and
a second state in which the gate signal is output to the first scanning line and a signal having the same frequency as the gate signal output to the first scanning line and having a different phase from the gate signal is output to the second scanning line.

2. The display device according to claim 1,
wherein the gate drive circuit selects, in accordance with the gate control signal, any one of the first state, the second state, and a third state in which a signal having a frequency equal to or less than half the frequency of the gate signal output to the first scanning line in the first state is output to the first scanning line and no gate signal is output to the second scanning line.

3. The display device according to claim 1, further comprising:
a second scanning line group including a third scanning line connected to a second transistor, out of the plurality of transistors, and a fourth scanning line connected to the second transistor,
wherein the gate drive circuit
selects, in accordance with the gate control signal, any one of the first state and the second state, and
selects, in accordance with the gate control signal, any one of a fourth state in which the gate signal is output to the third scanning line and no gate signal is output to the fourth scanning line and a fifth state in which the gate signal is output to the third scanning line and a signal having the same frequency as the gate signal output to the third scanning line and having a different phase from the gate signal is output to the fourth scanning line.

4. The display device according to claim 3,
wherein the gate drive circuit
selects, in accordance with the gate control signal, any one of the first state and the second state, and
selects, in accordance with the gate control signal, any one of the fourth state, the fifth state, and a sixth state in which a signal having a frequency equal to or less than half the frequency of the gate signal output to the third scanning line in the fourth state is output to the third scanning line.

5. The display device according to claim 1,
wherein the source line group includes a first source line group including a first source line connected to a third transistor, out of the plurality of transistors, and a second source line connected to the third transistor,
the control circuit outputs a source control signal to the source drive circuit, and
the source drive circuit selects, in accordance with the source control signal,
any one of a seventh state in which the source signal is output to the first source line and the source signal is not output to the second source line, and
an eighth state in which the source signal is output to the first source line, and a signal having the same frequency as the source signal output to the first source line and having a different phase from the source signal is output to the second source line.

6. The display device according to claim 5,
wherein the source drive circuit selects, in accordance with the source control signal, any one of the seventh state, the eighth state, and a ninth state in which a signal having a frequency equal to or less than half the frequency of the source signal output to the first source line in the seventh state is output to the first source line and no source signal is output to the second source line.

7. The display device according to claim 5, further comprising:
a second source line group including a third source line connected to a fourth transistor, out of the plurality of transistors, and a fourth source line connected to the fourth transistor,
wherein the source drive circuit
selects, in accordance with the source control signal, any one of the seventh state and the eighth state, and
selects, in accordance with the source control signal, any one of a tenth state in which the source signal is output to the third source line and no source signal is output to the fourth source line and an eleventh state in which the source signal is output to the third source line and a signal having the same frequency as the source signal output to the third source line and having a different phase from the source signal is output to the fourth source line.
